(19) United States
(12) Patent Application Publication
(10) Pub. No.: US 2014/0242449 A1
(43) Pub. Date: Aug. 28, 2014

(54) Pack Case for Battery

(71) Applicant: Samsung SDI Co., Ltd., Yongin-si (KR)

(72) Inventors: Jaewook Lee, Yongin-si (KR); Younho Lee, Yongin-si (KR); Yongwoo Kim, Yongin-si (KR); Sukhwan Lee, Yongin-si (KR)

(73) Assignee: Samsung SDI Co., Ltd., Yongin-si (KR)

(21) Appl. No.: 13/949,167

(22) Filed: Jul. 23, 2013

Related U.S. Application Data
(60) Provisional application No. 61/770,874, filed on Feb. 28, 2013.

(51) Int. Cl. H01M 2/10

(52) U.S. Cl. CPC H01M 2/1016; H01M 2/1022; H01M 2/1077
USPC 429/176

(57) ABSTRACT

An embodiment of the present invention provides a pack case for a battery, which has a simplified structure by increasing an internal coupling force and can increase a life span of a mold. In one embodiment, the pack case includes a first case and a second case to accommodate a plurality of battery cells therein, wherein the first case includes a first coupling member having a link hole formed at its edge, and the second case includes a second coupling member having a guide member and a locking ledge formed at its edge, so that the first coupling member moves along the guide member of the second coupling member, and the link hole of the first coupling member is engaged with the locking ledge of the second coupling member.

### CROSS-REFERENCE TO RELATED APPLICATION

This application claims priority to and the benefit of U.S. Provisional Application No. 61/770,874, filed on Feb. 28, 2013 in the U.S. Patent and Trademark Office, the entire content of which is incorporated herein by reference.

### BACKGROUND

1. Field

Aspects of embodiments according to the present invention relate to a pack case for a battery.

2. Description of the Related Art

Unlike a primary battery that is not designed to be recharged, a rechargeable battery can be repeatedly charged and discharged. A low-capacity rechargeable battery having a single cell is used, for example, in small portable electronic apparatuses, such as mobile phones, laptop computers, and camcorders. A large-capacity rechargeable battery that includes a plurality of rechargeable cells connected in a pack shape is used as, for example, a power source for driving a motor of a hybrid electric vehicle and the like.

Rechargeable batteries are manufactured in various shapes, for example, a cylindrical shape and a prismatic shape.

Rechargeable batteries are generally configured by housing an electrode assembly including a positive electrode, a negative electrode and a separator positioned between the positive and negative electrodes as an insulator in a case, together with an electrolyte, and sealing the case with a cap assembly. Positive and negative electrode terminals are connected to the electrode assembly and are exposed to protrude to the outside through the cap plate.

A plurality of rechargeable batteries are provided and inserted into a pack case according to the application field of the batteries and then connected to each other in series or parallel. Thus, because the rechargeable batteries are finally used in the form of a pack case, the pack case has a secured structure.

### SUMMARY

It is a feature of an embodiment according to the present invention to provide a pack case for a battery, which has a simplified structure by increasing an internal coupling force and can increase a life span of a mold used to manufacture the pack case.

In accordance with an embodiment of the present invention, a pack case for a battery includes: a first case including a first coupling member including a link hole; and a second case including a second coupling member including a guide member and a locking ledge, the first coupling member being configured to move along the guide member of the second coupling member and to engage the link hole of the first coupling member with the locking ledge of the second coupling member, and the first case and the second case being configured to accommodate one or more battery cells.

In some embodiments, a bottom area of the first coupling member is closed.

In some embodiments, the first coupling member includes an opening at a side of the link hole and the first coupling member is generally U-shaped.

In some embodiments, the guide member includes a guide groove passing through the guide member and the guide member is generally L-shaped.

The first coupling member may be configured to be inserted into and guided along the guide groove to engage the link hole of the first coupling member with the locking ledge of the second coupling member.

The first coupling member may be fixed at the locking ledge of the second coupling member and at the guide groove of the guide member.

The guide member may include a first guide member and a second guide member, and the locking ledge may be between the first and second guide members.

In some embodiments, a bottom area of the first coupling member spans between the first and second guide members to contact the first and second guide members.

A bottom portion of the locking ledge of the second coupling member may be perpendicular to a surface of the second case at which the locking ledge is located.

In some embodiments, the second coupling member further includes a slanted surface at an upper side of the locking ledge. The slanted surface of the second coupling member may be configured to apply a force to the first coupling member when the first coupling member is being coupled to the second coupling member.

The force may be applied to a center of the first coupling member, and the force may cause the first coupling member to resiliently deform.

In some embodiments, the first coupling member further includes an other link hole.

The link hole and the other link hole may be separated by a separation component at a center of the first coupling member.

The link hole and the other link hole may be arranged in a straight line along a length direction of the first coupling member.

In some embodiments, the second coupling member further includes an other locking ledge.

The locking ledge and the other locking ledge may be arranged in a straight line along a length direction of the second coupling member.

In some embodiments, the first coupling member further includes an other link hole, the second coupling member further includes an other locking ledge, and the link hole and the other link hole are configured to be coupled to the locking ledge and the other locking ledge, respectively.

In accordance with another embodiment of the present invention, a pack case for a battery includes: a first case including a first coupling member including a slanted surface and a locking ledge; and a second case including a second coupling member including a guide member, a slanted surface and a locking ledge, the first coupling member being configured to move along the guide member of the second coupling member and to engage the locking ledge of the first coupling member with the locking ledge of the second coupling member, and the first case and the second case being configured to accommodate one or more battery cells therebetween.

The slanted surface of the second coupling member may be configured to apply a force to the slanted surface of the first coupling member to resiliently deform the first coupling member when the first coupling member and the second coupling member are being coupled together.

In an embodiment of the pack case according to the present invention, the first coupling member having the link hole is at (e.g., formed at) an edge of the first case, and the second coupling member having the guide member and the locking ledge is at (e.g., formed at) an edge of the second case combined with the first case.

Thus, in some embodiments, the first coupling member moves along the guide member of the second coupling member, and the link hole of the first coupling member is engaged with the locking ledge of the second coupling member, thereby increasing the coupling force of the pack case and establishing secured engagement. According to an aspect of an embodiment according to the present invention, the number of coupling members, such as hooks, required for engagement is reduced, as compared to other pack cases and, therefore, the pack case according to embodiments of the present invention may have a simplified structure, and a mold for the manufacture of the pack case may be simplified, thereby increasing the life span of the mold.

### BRIEF DESCRIPTION OF THE DRAWINGS

The accompanying drawings, together with the specification, illustrate embodiments of the present invention, and, together with the description, serve to explain the principles of the present invention.

FIG. 1 is a perspective view of a pack case according to an embodiment of the present invention;

FIG. 2 is an exploded perspective view of the pack case shown in FIG. 1;

FIG. 3 is a transparent perspective view of a first case in the pack case shown in FIG. 1;

FIG. 4 is a perspective view of a second case in the pack case shown in FIG. 1;

FIG. 5a is an enlarged view of a first coupling member of the pack case shown in FIG. 1;

FIG. 5b is an enlarged view of a second coupling member of the pack case shown in FIG. 1;

FIGS. 5c and 5d are enlarged views illustrating a procedure in which the first coupling member and the second coupling member are coupled to each other in the pack case of FIG. 1;

FIG. 6a is an enlarged view of a first coupling member of a pack case according to another embodiment of the present invention;

FIG. 6b is an enlarged view illustrating a procedure in which the first coupling member and a second coupling member are coupled to each other in the pack case of FIG. 6a;

FIG. 7a is an enlarged view of a first coupling member of a pack case according to still another embodiment of the present invention;

FIG. 7b is an enlarged view illustrating a procedure in which the first coupling member and a second coupling member are coupled to each other in the pack case of FIG. 7a;

FIG. 8a is an enlarged view of a first coupling member of a pack case according to still another embodiment of the present invention;

FIG. 8b is an enlarged view of a second coupling member of a pack case according to still another embodiment of the present invention;

FIG. 8c is an enlarged view illustrating a procedure in which the first coupling member and the second coupling member are coupled to each other in the pack case of FIG. 8a;

FIG. 9a is an enlarged view of a first coupling member of a pack case according to still another embodiment of the present invention;

FIG. 9b is an enlarged view of a second coupling member of a pack case according to still another embodiment of the present invention; and

FIG. 9c is an enlarged view illustrating a procedure in which the first coupling member and the second coupling member are coupled to each other in the pack case of FIG. 9a.

### DETAILED DESCRIPTION

Example embodiments of the present invention will now be described in more detail with reference to accompanying drawings, such that those skilled in the art can easily practice the present invention. Only certain embodiments of the present invention are shown and described, by way of illustration. As those skilled in the art would recognize, the invention may be embodied in many different forms and should not be construed as being limited to the embodiments set forth herein. Also, in the context of the present application, when a first element is referred to as being “on” a second element, it can be directly on the second element or be indirectly on the second element with one or more intervening elements interposed therebetween. Like reference numerals designate like elements throughout the specification.

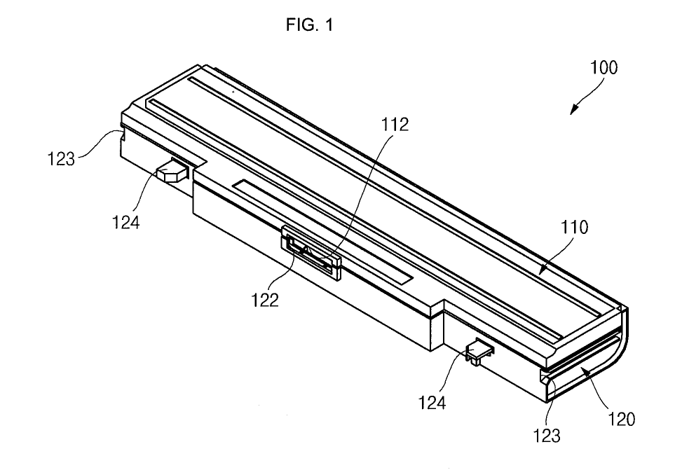

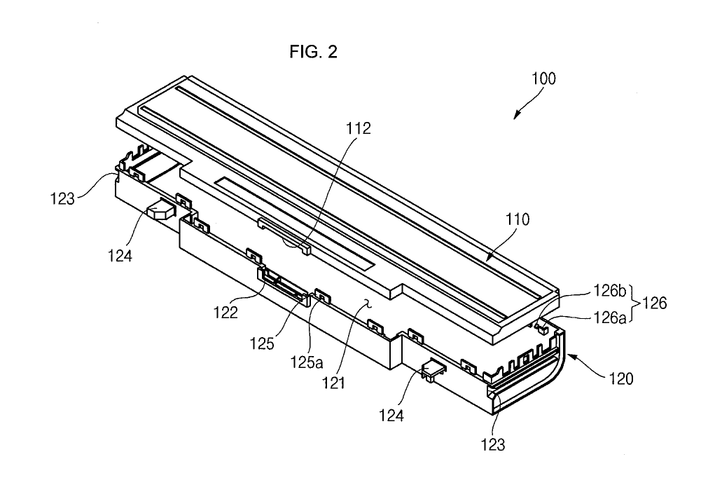

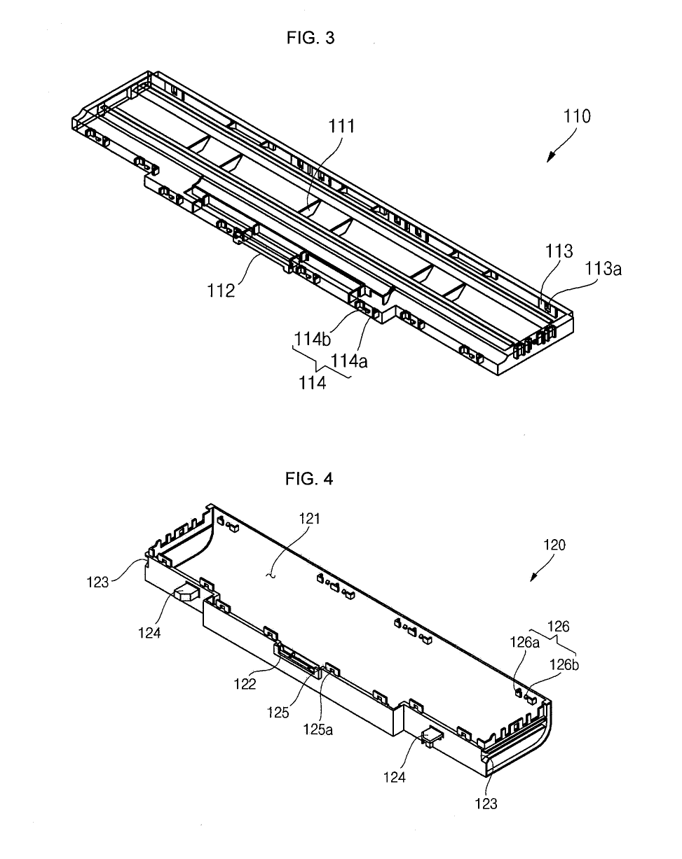

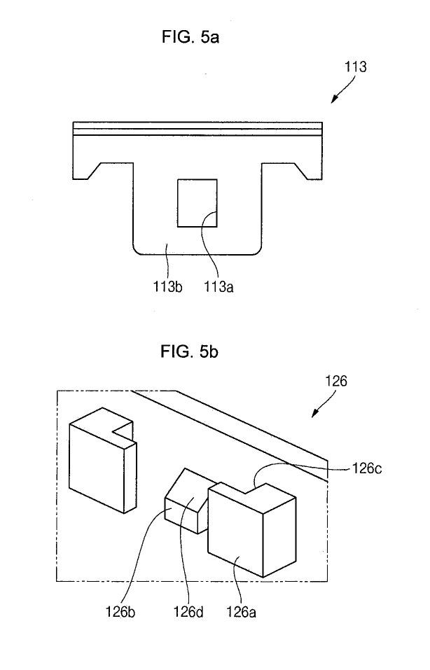

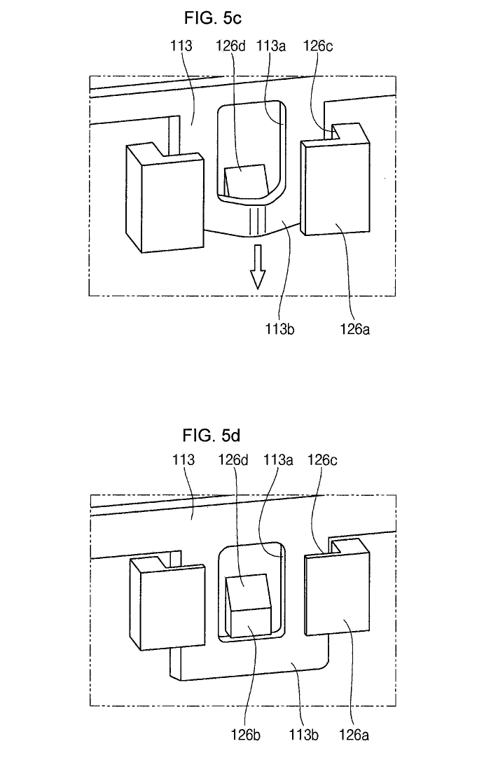

FIG. 1 is a perspective view of a pack case according to an embodiment of the present invention, FIG. 2 is an exploded perspective view of the pack case shown in FIG. 1, FIG. 3 is a transparent perspective view of a first case in the pack case shown in FIG. 1, FIG. 4 is a perspective view of a second case in the pack case shown in FIG. 1, FIG. 5a is an enlarged view illustrating a first coupling member provided in the pack case shown in FIG. 1, FIG. 5b is an enlarged view illustrating a second coupling member provided in the pack case shown in FIG. 1, and FIGS. 5c and 5d are enlarged views illustrating a procedure in which the first coupling member and the second coupling member are coupled to each other in the pack case shown in FIG. 1.

Referring to FIGS. 1 to 5d, the pack case 100 according to an embodiment of the present invention includes a first case 110 and a second case 120.

The first case 110 may be coupled to an upper side of the second case 120. The first case 110 may be made of a plastic material that is an electric insulator, but the present invention is not limited thereto.

In the embodiment shown in FIG. 3, the first case 110 includes barrier walls 111 provided therein to downwardly fix one or more battery cells accommodated in the pack case 100. In addition, the first case 110 has a connection part 112 to be connected to an external device, the connection part 112 being on (e.g., formed on) the inner surface perpendicular to a direction in which the pack case 100 is attached to/detached from the external device. A terminal of the external device may be connected to the first case 110 through the connection part 112, to thereby charge the battery cells positioned within the pack case 100 or receive power from the battery cells. For example, according to an embodiment of the present invention, a speedboat includes a motor configured to be powered by a battery including an embodiment of the pack case.

Referring to FIG. 5a, the first case 110 includes a first coupling member 113 at (e.g., formed at) one or more portions of its edge. The first coupling member 113 is shaped as a loop downwardly protruding from an edge of the first case 110. The first coupling member 113 has a link hole 113a formed therein, and a bottom area 113b of the link hole 113a is closed to have a substantially rectangular or square (‘▭’) shape (e.g., is generally rectangular or square shaped). Therefore, the second case 120 engaged with the link hole 113a is securely fixed by the bottom area 113b.

In addition, the first case 110 includes a second coupling member 114 formed at one or more portions of its edge. The second coupling member 114 is formed at an area other than the area where the first coupling member 113 is formed. A pair of the second coupling members 114 are provided, including a guide member 114a formed in a substantially ‘L’ shape (e.g., the guide member is generally L shaped), and a locking ledge 114b between (e.g., formed between) the guide members 114a. As will later be described, the second coupling member 114 is engaged with a loop-shaped first coupling member 125 formed in the second case 120 and including a link hole 125a. In this case, the guide member 114a guides an engaged direction (e.g., an engaging direction) of the first coupling member 125 of the second case 120, and the locking ledge 114b is coupled and fixed to the first coupling member 125 of the second case 120.

In addition, because the second coupling member 114 has the same (or substantially the same) configuration as the second coupling member 126 of the second case 120, it will be described in detail later in reference to the second coupling member 126 of the second case 120.

The second case 120 is combined with the first case 110. The second case 120 is coupled to a lower side of the first case 110. Like the first case 110, the second case 120 may also be made of a plastic material that is an electric insulator, but the present invention is not limited thereto.

In one embodiment, the second case 120 has an accommodation space 121 provided therein to accommodate one or more battery cells.

In addition, in some embodiments, the second case 120 has a connection part 122 to be connected to an external device, the connection part 122 formed on the inner surface perpendicular to a direction in which the pack case 100 is attached to/detached from the external device.

Connection leads are formed at opposite ends of the accommodation space 121, forming charge/discharge paths of the one or more battery cells, and may extend to the connection part 122 of the second case 120. The connection part 122 is matched with the connection part 112 of the first case 110, and the external device is connected to the matched connection parts 112 and 122, thereby charging the one or more battery cells or receiving power from the battery cells.

In addition, in some embodiments, the second case 120 has a coupling groove 123 formed along the short side parallel to a direction in which the pack case 100 is attached to/detached from the external device. A protrusion of the external device is coupled to the coupling groove 123, thereby guiding the pack case 100 to be connected to the external device.

In addition, in some embodiments, the second case 120 includes an assembling/disassembling protrusion 124 formed on the inner surface perpendicular to a direction in which the pack case 100 is attached to/detached from the external device. The assembling/disassembling protrusion 124 is engaged with the external device, thereby assembling or disassembling the pack case 100 by maintaining a connected state of the pack case 100 when it is connected to the external device or canceling the connected state from the external device.

In some embodiments, the second case 120 has a first coupling member 125 formed at a portion of its edge. The first coupling member 125 has the same (or substantially the same) configuration as the first coupling member 113 of the first case 110. For example, in some embodiments, the first coupling member 125 has a substantially rectangular or square (‘▭’) shape (e.g., is generally rectangular shaped or generally square shaped) by a link hole 125a formed therein. The link hole 125a is engaged with the locking ledge 114b formed in the second coupling member 114 of the first case 110.

Referring to FIG. 5b, the second case 120 includes a second coupling member 126. A pair of the second coupling members 126 are provided, including a guide member 126a formed in a substantially 1′ shape (e.g., the guide member is generally L shaped), and a locking ledge 126b formed between the guide members 126a.

In some embodiments, the guide member 126a includes guide grooves 126c provided therein. The guide grooves 126c are formed to vertically pass through the guide member 126a. The first coupling member 113 of the first case 110 is inserted into and guided along the guide grooves 126c of the guide member 126a, and moves downward to be coupled to the guide grooves 126c.

The locking ledge 126b protrudes between the guide members 126a. While a bottom portion of the locking ledge 126b is perpendicular to the second case 120, a top portion of the locking ledge 126b is tilted with respect to the second case 120 to have a slanting (e.g., slanted) surface 126d.

Referring to FIG. 5c, the slanting (e.g., slanted) surface 126d may guide the bottom area 113b of the first coupling member 113 to be bent when the first coupling member 113 of the first case 110 descends. For example, the slanted surface 126d may be configured to apply a force to the first coupling member 113 when the first coupling member is being coupled to the second coupling member. The force may be applied to a center of the coupling member 113, and the force may cause the first coupling member 113 to resiliently deform. Accordingly, the first coupling member 113 may be easily fixed to the bottom portion of the locking ledge 126b.

In addition, referring to FIG. 5d, in a state in which coupling is completed, the bottom area 113b of the first coupling member 113 of the first case 110 is fixed in all directions (or at least three directions) by the locking ledge 126b and the guide member 126a formed in the second coupling member 126 of the second case 120, thereby preventing the first case 110 and the second case 120 from being disassembled from each other (or reducing the likelihood of the first case 110 and the second case 120 being disassembled from each other). Therefore, the pack case 100 according to this embodiment of the present invention has an improved coupling force, thereby reducing the number of coupling members, such as hooks for coupling, compared to the conventional pack case. Accordingly, the pack case 100 may have a simplified structure, and a mold for the manufacture of the pack case 100 may also be simplified, thereby increasing the life span of the mold.

In addition, although not separately described, the first coupling member 113 of the first case 110 has the same (or substantially the same) configuration as the first coupling member 125 of the second case 120, and the second coupling member 114 of the first case 110 has the same (or substantially the same) configuration as the second coupling member 126 of the second case 120. For example, in some embodiments, the first coupling member 125 of the second case 120 is inserted into the second coupling member 114 of the first case 110 to be coupled to the second coupling member 114 in the same (or substantially the same) manner as described above.

Hereinafter, a configuration of a pack case according to another embodiment of the present invention will be described.

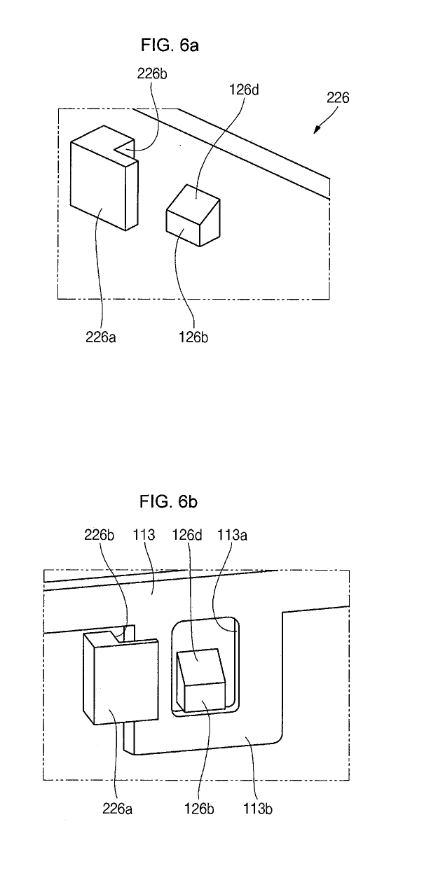

FIG. 6a is an enlarged view illustrating a second coupling member provided in a pack case according to another embodiment of the present invention, and FIG. 6b is an enlarged view illustrating a procedure in which the first coupling member and a second coupling member are coupled to each other in the pack case shown in FIG. 6a.

The same (or substantially the same) functional components and operations as those of the previous embodiment are denoted by the same reference numerals, and the following description will focus on differences between the present and previous embodiments.

Referring to FIG. 6a, in the pack case according to another embodiment of the present invention, a second coupling member 226 of a second case includes a guide hole (or guide groove) 226b provided therein to guide a first coupling member 113 of the first case.

Referring to FIG. 6b, after coupling is completed, the first coupling member 113 of the first case is maintained at a fixed state by a guide member 226a and a locking ledge 126b.

Hereinafter, a configuration of a pack case according to still another embodiment of the present invention will be described.

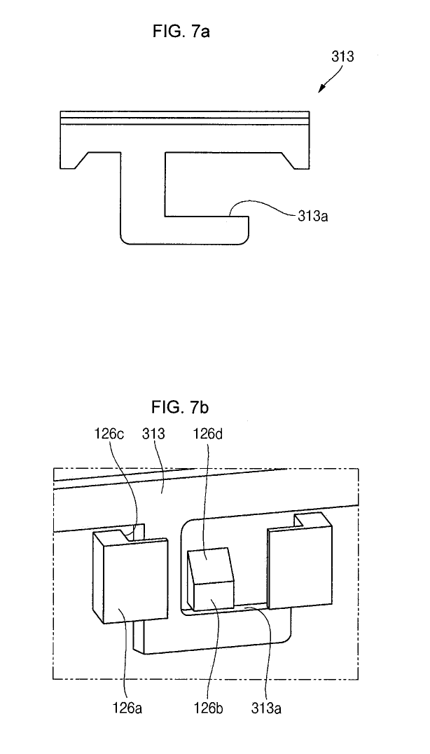

FIG. 7a is an enlarged view illustrating a first coupling member provided in a pack case according to still another embodiment of the present invention, and FIG. 7b is an enlarged view illustrating a procedure in which the first coupling member and a second coupling member are coupled to each other in the pack case shown in FIG. 7a.

Referring to FIG. 7a, in the pack case according to still another embodiment of the present invention, a first coupling member 313 of a first case includes a link hole 313a having an open side to have a substantially ‘U’ shape (e.g., to be generally U shaped).

Referring to FIG. 7b, similarly to the previous embodiment, in the present embodiment, after coupling is completed, the first coupling member 313 of the first case is maintained at a fixed state by a guide member 126a and a locking ledge 126b.

Hereinafter, a configuration of a pack case according to still another embodiment of the present invention will be described.

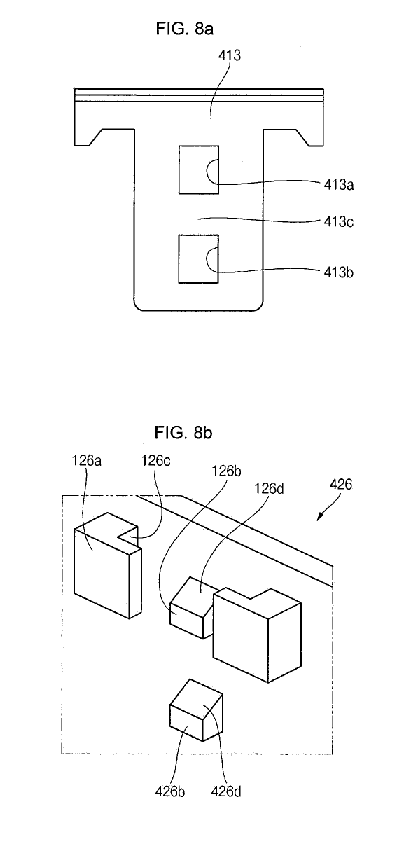

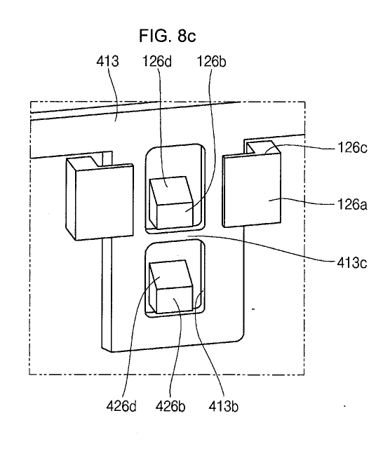

FIG. 8a is an enlarged view illustrating a first coupling member provided in a pack case according to still another embodiment of the present invention, FIG. 8b is an enlarged view illustrating a second coupling member provided in a pack case according to still another embodiment of the present invention, and FIG. 8c is an enlarged view illustrating a procedure in which the first coupling member of FIG. 8a and the second coupling member of FIG. 8b are coupled to each other.

Referring to FIG. 8a, in the pack case according to this embodiment of the present invention, a first coupling member 413 of a first case includes two link holes 413a and 413b (e.g., a link hole 413a and an other link hole 413b) provided therein and has a separation part (e.g., separation component) 413c formed at its center. The link holes 413a and 413b are arranged to form a straight line in a vertical direction. For example, the link hole 413a and the other link hole 413b may be arranged in a straight line along a length direction of the first coupling member 413.

In addition, referring to FIG. 8b, a second coupling member 426 of a second case includes two locking ledges 126b and 426b (e.g., a locking ledge 126b and an other locking ledge 426b) so as to correspond to the first coupling member 413. The locking ledges 126b and 426b are arranged to form a straight line in a vertical direction. For example, the locking ledge 126b and the other locking ledge 426b may be arranged in a straight line along a length direction of the second coupling member 426. The second coupling member may further include a slanted surface 126d and an other slanted surface 426d.

Therefore, as shown in FIG. 8c, if coupling is completed along the guide member 126a of the second coupling member 426, the link holes 413a and 413b forming the first coupling member 423 of the first case are coupled to the locking ledges 126b and 426b, respectively. Therefore, when coupled together, the first coupling member 413 of the first case is fixed by the second coupling member 426 of the second case.

Hereinafter, a configuration of a pack case according to still another embodiment of the present invention will be described.

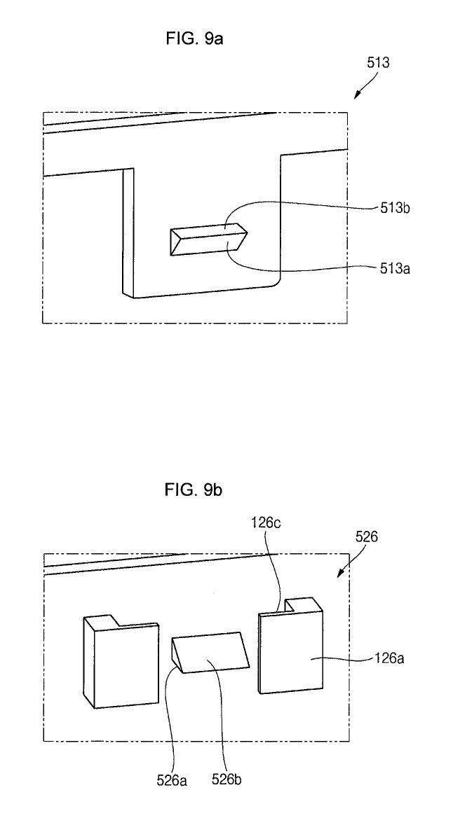

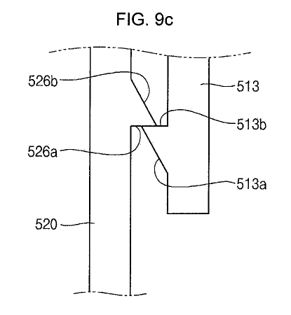

FIG. 9a is an enlarged view illustrating a first coupling member provided in a pack case according to still another embodiment of the present invention, FIG. 9b is an enlarged view illustrating a second coupling member provided in a pack case according to still another embodiment of the present invention, and FIG. 9c is an enlarged view illustrating a procedure in which the first coupling member of FIG. 9a and the second coupling member of FIG. 9b are coupled to each other.

Referring to FIG. 9a, in the pack case according to still another embodiment of the present invention, a bottom portion of a first coupling member 513 of a first case has a slanting (e.g., slanted) surface 513a, and a locking ledge 513b is formed at a top portion of the first coupling member 513.

In addition, referring to FIG. 9b, a second coupling member 526 of a second case includes a locking ledge 526a and a slanting (e.g., slanted) surface 526b between a pair of guide members 126a so as to correspond to the first coupling member 413. The locking ledge 526a is formed at a bottom portion of the second coupling member 526, and the slanting (e.g., slanted) surface 526b is formed at a top portion of the second coupling member 526.

Referring to FIG. 9c, the slanting (e.g., slanted) surface 513a forming the first coupling member 513 of the first case moves downward while deforming the slanting (e.g., slanted) surface 526b forming the second coupling member 526 of the second case. In addition, after the moving is completed, the locking ledge 513b of the first coupling member 513 is engaged with the locking ledge 526a of the second coupling member 526, thereby fixing final positions of the first and second coupling members 513 and 526. In addition, in the engaged state, the locking ledges 513b and 526b are engaged with each other to then be fixed, and sides of the first and second coupling members 513 and 526 are fixed by the guide member 126a. Therefore, the first coupling member 513 of the first case can be combined with the second coupling member 526 of the second case in a secured manner.

While the pack case of the invention has been described in connection with a certain embodiment, it will be understood by those skilled in the art that the invention is not limited to the disclosed embodiments, but rather is intended to cover various modifications included within the spirit and scope of the appended claims and equivalents thereof.

### EXPLANATION OF SOME OF THE REFERENCE NUMERALS

100: Pack case 110: First case
113: First coupling member 113a: Link hole
114: Second coupling member 114a: Guide member
114b: Locking ledge 120: Second case
125: First coupling member 125a: Link hole
126: Second coupling member 126a: Guide member
126b: Locking ledge

What is claimed is:

1. A pack case for a battery, the pack case comprising:
a first case comprising a first coupling member comprising a link hole; and
a second case comprising a second coupling member comprising a guide member and a locking ledge,
the first coupling member being configured to move along the guide member of the second coupling member and to engage the link hole of the first coupling member with the locking ledge of the second coupling member, and
the first case and the second case being configured to accommodate one or more battery cells therebetween.

2. The pack case of claim 1, wherein a bottom area of the first coupling member is closed.

3. The pack case of claim 1, wherein the first coupling member comprises an opening at a side of the link hole and the first coupling member is generally U shaped.

4. The pack case of claim 1, wherein the guide member comprises a guide groove passing through the guide member and the guide member is generally L shaped.

5. The pack case of claim 4, wherein the first coupling member is configured to be inserted into and guided along the guide groove to engage the link hole of the first coupling member with the locking ledge of the second coupling member.

6. The pack case of claim 4, wherein the first coupling member is fixed at the locking ledge of the second coupling member and at the guide groove of the guide member.

7. The pack case of claim 1, wherein the guide member comprises a first guide member and a second guide member, and the locking ledge is between the first and second guide members.

8. The pack case of claim 7, wherein a bottom area of the first coupling member spans between the first and second guide members to contact the first and second guide members.

9. The pack case of claim 1, wherein a bottom portion of the locking ledge of the second coupling member is perpendicular to a surface of the second case at which the locking ledge is located.

10. The pack case of claim 1, wherein the second coupling member further comprises a slanted surface at an upper side of the locking ledge.

11. The pack case of claim 10, wherein the slanted surface of the second coupling member is configured to apply a force to the first coupling member when the first coupling member is being coupled to the second coupling member.

12. The pack case of claim 11, wherein the force is applied to a center of the first coupling member, and the force causes the first coupling member to resiliently deform.

13. The pack case of claim 1, wherein the first coupling member further comprises an other link hole.

14. The pack case of claim 13, wherein the link hole and the other link hole are separated by a separation component at a center of the first coupling member.

15. The pack case of claim 13, wherein the link hole and the other link hole are arranged in a straight line along a length direction of the first coupling member.

16. The pack case of claim 1, wherein the second coupling member further comprises an other locking ledge.

17. The pack case of claim 16, wherein the locking ledge and the other locking ledge are arranged in a straight line along a length direction of the second coupling member.

18. The pack case of claim 1, wherein the first coupling member further comprises an other link hole, the second coupling member further comprises an other locking ledge, and the link hole and the other link hole are configured to be coupled to the locking ledge and the other locking ledge, respectively.

19. A pack case for a battery, the pack case comprising:
a first case comprising a first coupling member comprising a slanted surface and a locking ledge; and
a second case comprising a second coupling member comprising a guide member, a slanted surface and a locking ledge,
the first coupling member being configured to move along the guide member of the second coupling member and to engage the locking ledge of the first coupling member with the locking ledge of the second coupling member, and
the first case and the second case being configured to accommodate one or more battery cells therebetween.

20. The pack case of claim 19, wherein the slanted surface of the second coupling member is configured to apply a force to the slanted surface of the first coupling member to resiliently deform the first coupling member when the first coupling member and the second coupling member are being coupled together.
